(19) United States
(12) Patent Application Publication
(10) Pub. No.: US 2016/0059371 A1
(43) Pub. Date: Mar. 3, 2016

(54) SYSTEM FOR MACHINING SURFACE OF WORKPIECE AND METHOD THEREOF

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN)

(21) Appl. No.: 14/559,461

(22) Filed: Dec. 3, 2014

(30) Foreign Application Priority Data
Sep. 1, 2014 (CN) 201410441190.0

(51) Int. Cl. B23Q 17/24; G05B 19/402; B23Q 17/20

(52) U.S. Cl. CPC B23Q 17/2471; B23Q 17/20; G05B 19/402; G05B 2219/37402

(57) ABSTRACT

A method for machining a surface of a workpiece includes setting a plane of the workpiece as an XY plane, aligning an axis of a machining tool to be within a predetermined angle with a normal vector of the XY plane, calculating a reference plane of the surface of the workpiece, defining a plurality of rectangular sections of the surface of the workpiece, defining a continuous machining path from a start point of a first rectangular section to an end point of a last rectangular section, calculating a center point of a plurality of planes of each rectangular section, and adjusting a Z-coordinate position of the machining tool according to a Z-coordinate difference between each of the plurality of planes and the reference plane. The Z-coordinate position of the machining tool is adjusted while the machining tool machines the surface of the workpiece along the continuous machining path.

### FIELD

The present disclosure relates to machining technologies, and more particularly to a system and method for machining a surface of a workpiece.

### BACKGROUND

A surface of a workpiece can be machined by a machining tool of a computer numerical control (CNC) device. A precision of flatness of the surface of the workpiece can be measured after being machined.

### BRIEF DESCRIPTION OF THE DRAWINGS

Implementations of the present technology will now be described, by way of example only, with reference to the attached figures.

FIG. 1 is a block diagram of an exemplary embodiment of a system for machining a surface of a workpiece, the system including a computing device and a computer numerical control (CNC) device.

FIG. 2 is a block diagram of an exemplary embodiment of function modules of a first machining program of the computing device.

FIG. 3 is a diagram of an exemplary embodiment of a process of machining the surface of the workpiece.

FIGS. 4-5 are a flowchart of an exemplary method for machining the surface of the workpiece.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

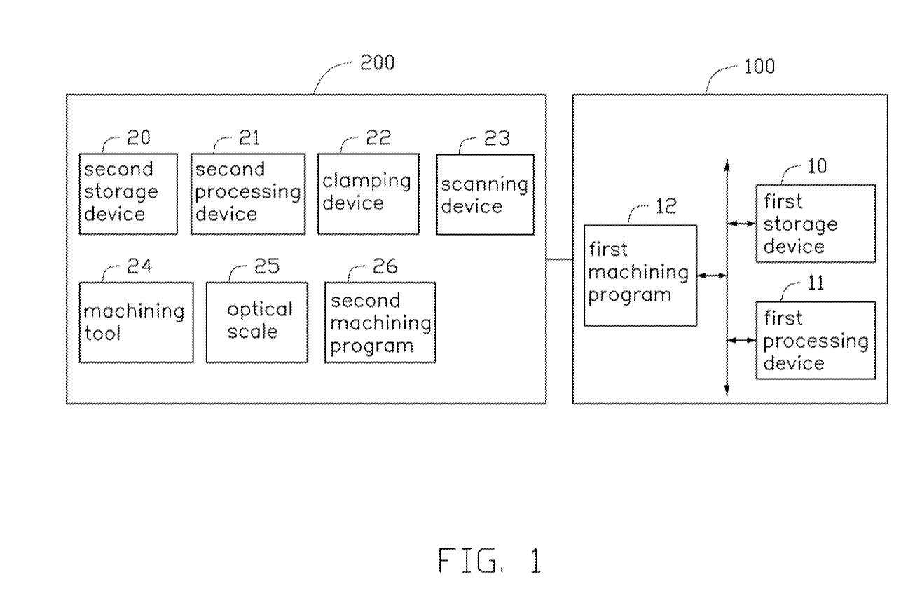

FIG. 1 illustrates an exemplary embodiment of a system for machining a surface of a workpiece (not shown). The system can include a computing device 100 coupled to a computer numeric control (CNC) device 200. The computing device 100 can be a personal computer, a tablet, or any other suitable electronic device. The computing device 100 can obtain and generate data of the surface of the workpiece, and provide the data to the CNC device 200. The CNC device 200 can machine the surface of the workpiece according to the data provided by the computing device 100.

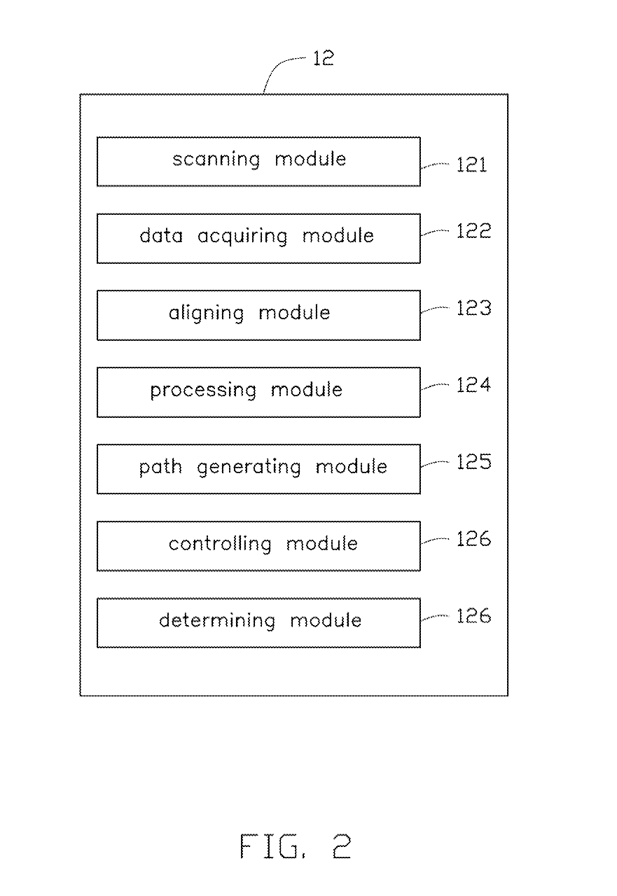

The computing device 100 can include a first storage device 10, a first processing device 11, and a first machining program 12. The first machining program 12 can include a plurality of modules (shown in FIG. 2) for obtaining and generating the data of the surface of the workpiece.

The CNC device 200 can include a second storage device 20, a second processing device 21, a clamping device 22, a scanning device 23, a machining tool 24, an optical scale 25, and a second machining program 26. The clamping device 22 can clamp the workpiece to move the workpiece to a worktable (not shown) for machining. The scanning device 23 can scan the surface of the workpiece. In at least one embodiment, the scanning device 23 can include three laser emitters (not shown). Laser points emitted by the laser emitters can form a plane on the surface of the workpiece. The machining tool 24 can machine the surface of the workpiece. The optical scale 25 can measure a coordinate value of a plurality of points of the surface of the workpiece. The second machining program 26 can include one or more software programs in the form of computerized codes stored in the second storage device 20. The computerized codes can include instructions executed by the second processing device 21 to provide functions for the second machining program 26.

Referring to FIG. 2, the first machining program 12 can include a scanning module 121, a data acquiring module 122, an aligning module 123, a processing module 124, a path generating module 125, a controlling module 126, and a determining module 127. The modules 121-127 can include one or more software programs in the form of computerized codes stored in the first storage device 10. The computerized codes can include instructions executed by the first processing device 11 to provide functions for the modules 121-127.

The scanning module 121 can control the scanning device of the CNC device to scan a plurality of points of the surface of the workpiece. The plurality of points can include a first set of points.

The data acquiring module 122 can obtain a plane formed by the first set of points scanned by the scanning device, and set the plane as an XY plane of an XYZ coordinate system. In at least one embodiment, a number of the first set of points is three.

The aligning module 123 can align an axis of the CNC device 200 according to the XY plane. The axis of the CNC device 200 can be aligned to within five degrees of a normal vector of the XY plane.

The plurality of points scanned by the scanning module 121 can further include a second set of points. In at least one embodiment, a number of the second set of points is at least four. The second set of points can include four points corresponding to four corners of a rectangular area of the surface of the workpiece to be machined. The processing module 124 can calculate a plane of best fit from the second set of points, and set the plane of best fit as a reference plane. The reference plane is set to be coplanar with the XY plane. The plane of best fit can be calculated by determining a minimum value calculated from the following equation:

$$f ( X ) = Min \sqrt{\frac{{\sum }_{n = 1}^{n} {( \sqrt{{( X 2 - X 1 )}^{2} + {( Y 2 - Y 1 )}^{2} + {( Z 2 - Z 1 )}^{2}} )}^{2}}{n}}$$

wherein:
X1, Y1, and Z1 are the coordinate points of the second set of points;
X2, Y2, and Z2 are the coordinate points of the plane of best fit at positions corresponding to the second set of points; and
n is the total number of points of the second set of points.

The processing module 124 also can calculate a flatness of the surface of the workpiece according to the reference plane.

The path generating module 125 can define a plurality of rectangular sections of the rectangular area of the workpiece to be machined, and set a start point and an end point of each rectangular section. A continuous machining path is obtained by connecting the start and end points together. The continuous machining path starts from the start point of a first rectangular section, and ends at the end point of a last rectangular section. The first rectangular section and the last rectangular section can be located at opposite sides of the rectangular area. In at least one embodiment, a width of each rectangular section is not greater than three times a precision of a flatness of the surface of the workpiece. For example, if the surface of the workpiece requires a precision of 0.001 mm, then the width of each rectangular section is not greater than 0.003 mm.

During a machining process, the scanning module 121 can control the scanning device to scan a plurality of sets of points of each rectangular section. Each set of points can include three points not on a same line, and each set of points can form a plane. The optical scale of the CNC device can measure a Z-coordinate position of each point scanned by the scanning device. The processing module 124 can determine a Z-coordinate position of a center point of each plane, and calculate a Z-coordinate difference between the center point of each plane and the reference plane. The processing module 124 can report the Z-coordinate difference to the second machining program of the CNC device, and the CNC device can adjust a Z-coordinate position of the machining tool according to the Z-coordinate difference to machine the surface of the workpiece. The Z-coordinate position of the machining tool can be adjusted for each set of points scanned of each rectangular section. The controlling module 126 can control the machining tool to machine the surface of the workpiece by following the continuous machining path while the scanning device scans the plurality of sets of points of each rectangular section. When the machining tool reaches the end point of a rectangular section, the controlling module 126 controls the machining tool to move to the start point of a next rectangular section, until the machining tool reaches the end point of the last rectangular section.

When the machining tool reaches the end point of the last rectangular section, the processing module 124 can recalculate the reference plane of the surface of the workpiece. The determining module 127 can determine whether the flatness precision of the recalculated reference plane is qualified. If the flatness precision of the recalculated reference plane is unqualified, the surface of the workpiece can be machined again as described above.

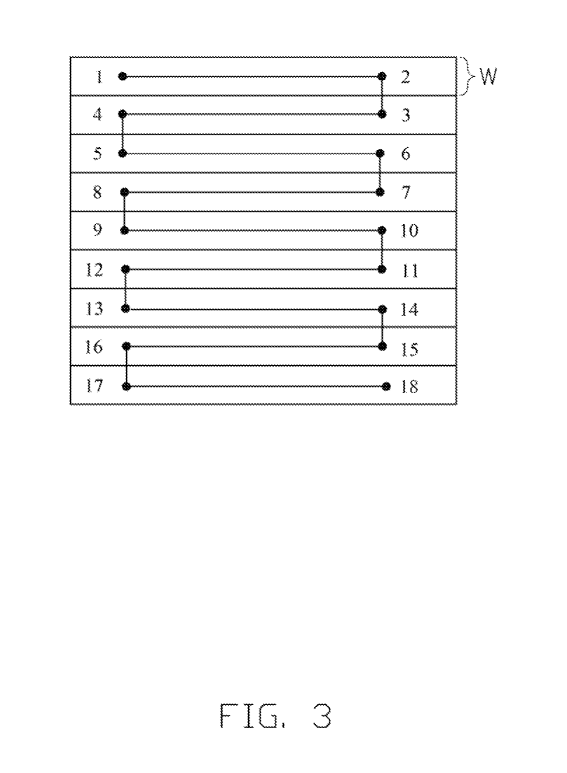

FIG. 3 illustrates an exemplary embodiment of the plurality of rectangular sections of the rectangular area to be machined. The continuous machining path can start at the start point of the first rectangular section, and end at the end point of the last rectangular section. Each rectangular section can have a width “W” that does not exceed three times the required precision of flatness of the surface of the workpiece.

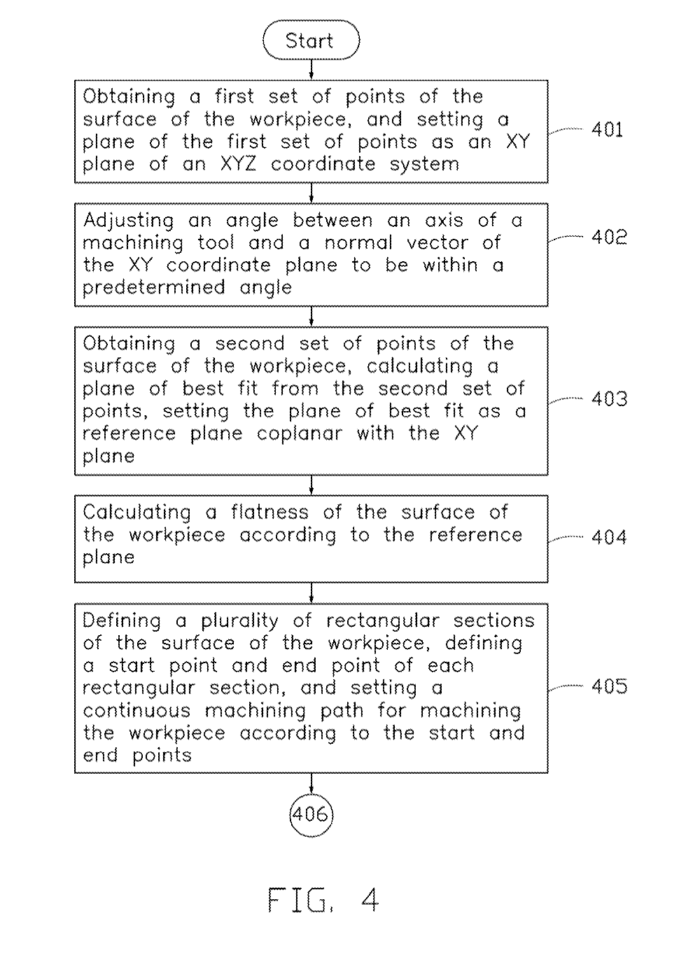

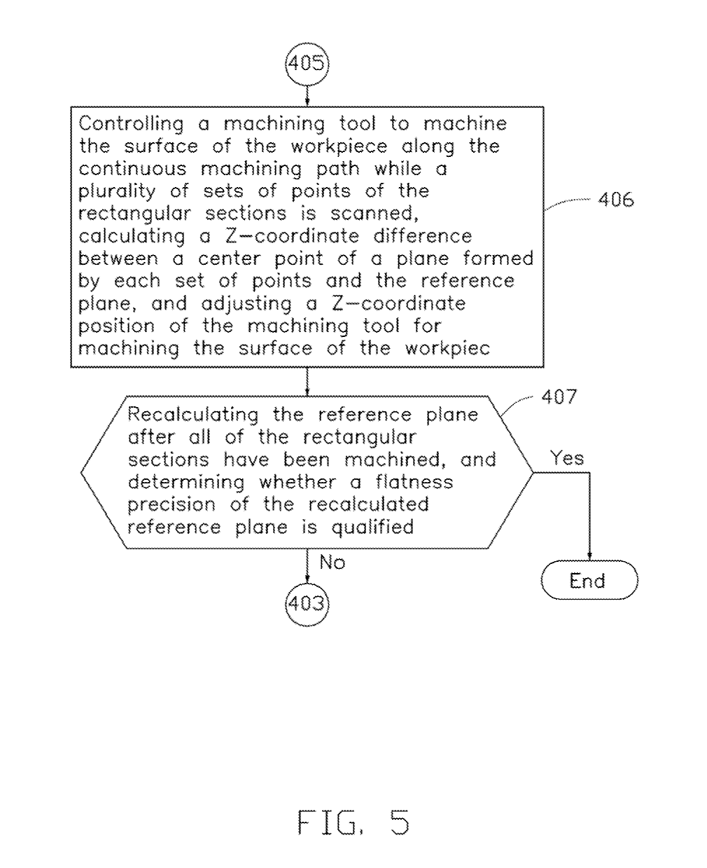

FIGS. 4-5 illustrates a flowchart of an exemplary method for machining a surface of a workpiece. The example method is provided by way of example, as there are a variety of ways to carry out the method. The method described below can be carried out using the configurations illustrated in FIGS. 1-2, for example, and various elements of these figures are referenced in explaining the example method. Each block shown in FIG. 5 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 401.

At block 401, a first set of points of the surface of the workpiece can be obtained. The first set of points can form a plane, and a plane of the first set of points can be set as an XY plane of an XYZ coordinate system.

At block 402, an angle between an axis of a machining tool and a normal vector of the XY coordinate plane can be adjusted to be within a predetermined angle. In at least one embodiment, the predetermined angle is 5 degrees.

At block 403, a second set of points of the surface of the workpiece can be obtained. The second set of points can include four points corresponding to four corners of a rectangular area to be machined. A plane of best fit can be calculated from the second set of points, and the plane of best fit can be set as a reference plane. The reference plane is coplanar with the XY plane.

At block 404, a flatness of the surface of the workpiece can be calculated according to the reference plane.

At block 405, a plurality of rectangular sections of the rectangular area can be defined, and a start point and end point of each rectangular section can be defined. A continuous machining path for machining the workpiece can be set according to the start and end points. The continuous machining path can start from the start point of a first rectangular section, and end at the end point of a last rectangular section. The first rectangular section and the last rectangular section can be located at opposite sides of the rectangular area.

At block 406, a machining tool can be controlled to machine the surface of the workpiece along the continuous machining path while a plurality of sets of points of the rectangular section currently being machined is scanned. Each set of points can form a plane. A Z-coordinate difference between a center point of the plane of each set of points and the reference plane can be calculated. A Z-coordinate position of the machining tool for machining the surface of the workpiece can be adjusted for each plane according to the Z-coordinate difference.

At block 407, the reference plane can be recalculated after all of the rectangular sections have been machined. Whether a flatness precision of the recalculated reference plane is qualified can be determined. If the flatness precision of the recalculated reference plane is not qualified, block 403 can be implemented. If the flatness precision of the recalculated reference plane is qualified, the method ends.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for machining a surface of a workpiece, the method comprising:
obtaining a first set of points of the surface of the workpiece, the first set of points not on a same line;
setting a plane of the first set of points as an XY plane of an XYZ coordinate system;
adjusting an angle between an axis of a machining tool and a normal vector of the coordinate plane to be within a predetermined angle;
obtaining a second set of points of the surface of the workpiece, calculating a plane of best fit from the second set of points, and setting the plane of best fit as a reference plane, the reference plane being coplanar with the XY plane;
calculating a flatness of the surface of the workpiece according to the reference plane;
defining a plurality of rectangular sections of the surface of the workpiece, defining a start point and end point of each rectangular section, and setting a continuous machining path for machining the workpiece according to the start and end points, the continuous machining path starting at the start point of a first rectangular section and ending at the end point of a last rectangular section;
obtaining at least one set of points of the surface of each rectangular section to be machined, the at least three points forming a plane;
calculating a Z-coordinate difference between a center point of the plane of the at least one set of points of each rectangular section and the reference plane;
controlling the machining tool to machine the surface of the workpiece at the center point of the plane of the at least one set of point of each rectangular section by adjusting a Z-coordinate position of the machining tool according to the Z-coordinate difference as the machining tool moves along the continuous machining path;
recalculating the reference plane after all of the rectangular sections have been machined, and determining whether a flatness of the surface of the workpiece is qualified according to the recalculated reference plane; and
remachining the surface of the workpiece, if the flatness of the workpiece is not qualified.

2. The method as in claim 1, wherein the workpiece is machined by a machining tool of a computer numerical control device.

3. The method as in claim 1, wherein the first set of points, the second set of points, and the at least one set of points of each rectangular section are obtained by a laser scanner scanning the surface of the workpiece.

4. The method as in claim 1, wherein a number of the first set of points is three, and the three points are not on a same line.

5. The method as in claim 1, wherein a number of the second set of points is at least four, and the second set of points comprises four points corresponding to four corners of a rectangular area of the surface of the workpiece to be machined.

6. The method as in claim 1, wherein a plurality of sets of points of each rectangular section is obtained, each set of points corresponds to a plane having a Z-coordinate center point, and the Z-coordinate position of the machining tool is adjusted according to a Z-coordinate difference between the reference plane and the plane corresponding to each set of points.

7. The method as in claim 1, wherein the reference plane is determined by a minimum value calculated from the following equation:
$$f ( X ) = Min \sqrt{\frac{{\sum }_{n = 1}^{n} {( \sqrt{{( X 2 - X 1 )}^{2} + {( Y 2 - Y 1 )}^{2} + {( Z 2 - Z 1 )}^{2}} )}^{2}}{n}}$$
wherein:
X1, Y1, and Z1 are the coordinate points of the second set of points;
X2, Y2, and Z2 are the coordinate points of the plane of the first set of points at positions corresponding to the second set of points; and
n is the total number of points of the second set of points.

8. The method as in claim 1, wherein the Z-coordinates are determined by an optical scale.

9. The method as in claim 1, wherein the angle between the axis of the machining tool and the normal vector is adjusted to be less than or equal to five degrees.

10. The method as in claim 1, wherein a width of each rectangular section is not greater than three times a precision of a flatness of the surface of the workpiece.

11. A system for machining a surface of a workpiece, the system comprising:
a computing device configured to obtain and generate data of the surface of the workpiece while the workpiece is being machined, the computing device comprising:
a storage device configured to store a plurality of instructions of a first machining program, the first machining program being configured to obtain and generate the data of the surface of the workpiece; and
a processing device configured to execute the plurality of instructions of the first machining program; and
a computer numerical control (CNC) device configured to machine the surface of the workpiece; the CNC device comprising:
a clamping device configured to clamp the workpiece;
a scanning device configured to scan the surface of the workpiece;
an optical scale configured to obtain coordinate values of a plurality of points of the surface of the workpiece;
a machining tool configured to machine the surface of the workpiece;
a storage device configured to store a plurality of instructions of a second machining program, the second machining program configured to control the machining tool to machine the surface of the workpiece according to the data obtained and generated by the computing device; and
a processing device configured to execute the plurality of instructions of the second machining program.

12. The system as in claim 11, wherein the first machining program comprises:
a scanning module configured to control the scanning device to scan the surface of the workpiece;
a data acquiring module configured to acquire a plurality of points scanned by the scanning device of the CNC device;
an aligning module configured to align the machining tool according to the plurality of points scanned by the scanning device;
a processing module configured to calculate a plane of best fit from a plurality of points scanned by the scanning device, set the plane of best fit as a reference plane, calculate a Z-coordinate difference between scanned points of the surface of the workpiece and the reference plane, and calculate a flatness of the surface of the workpiece according to the reference plane;
a path generating module configured to define a plurality of rectangular sections of the surface of the workpiece, define a start point and end point of each rectangular section for machining, and define a continuous machining path for machining the surface of the workpiece according to the start and end points;
a controlling module configured to control the machining tool to machine each rectangular section of the workpiece along the continuous machining path; and
a determining module configured to determine whether all of the rectangular sections have finished being machined, and determine a flatness of the surface of the workpiece according to the reference plane.

13. The system as in claim 11, wherein the scanning device comprises at least three laser emitters; and the laser points emitted by the at least three laser emitters are not on a same line.

14. The system as in claim 12, wherein the scanning module controls the scanning device to scan a first set of points, a second set of points, and a plurality of sets of points of each rectangular section.

15. The system as in claim 14, wherein a number of the first set of points is three, a number of the second set of points is at least four, and a number of each set of points of each rectangular section is three.

16. The system as in claim 15, wherein:
the data acquiring module defines a plane formed by the first set of points as an XY plane of an XYZ coordinate system;
the aligning module aligns the axis of the machining tool to be within five degrees of a normal vector of the XY plane;
the second set of points comprises four points corresponding to four corners of a rectangular area of the surface of the workpiece to be machined; and
each set of points scanned of each rectangular section forms a plane.

17. The system as in claim 16, wherein the reference plane is determined by a minimum value calculated from the following equation:
$$f ( X ) = Min \sqrt{\frac{{\sum }_{n = 1}^{n} {( \sqrt{{( X 2 - X 1 )}^{2} + {( Y 2 - Y 1 )}^{2} + {( Z 2 - Z 1 )}^{2}} )}^{2}}{n}}$$
wherein:
X1, Y1, and Z1 are the coordinate points of the second set of points;
X2, Y2, and Z2 are the coordinate points of the plane of the first set of points at positions corresponding to the second set of points; and
n is the total number of points of the second set of points.

18. The system as in claim 16, wherein the processing module calculates a center point of each plane formed by the plurality of sets of points of each rectangular section, calculates a Z-coordinate difference between the center point of each plane and the reference plane, and adjusts a Z-coordinate position of the machining tool according to the Z-coordinate difference.

19. The system as in claim 18, wherein the optical scale measures the Z-coordinate position of the machining tool; the controlling module controls the second machining program to adjust the Z-coordinate value of the machining tool and while the machining tool is moved along the continuous machining path.

20. The system as in claim 12, wherein a width of each rectangular section is not greater than three times a required precision of flatness of the surface of the workpiece.
